(19) United States
(12) Patent Application Publication
(10) Pub. No.: US 2020/0153288 A1
(43) Pub. Date: May 14, 2020

(54) WIRELESSLY-POWERED ELECTRONIC DEVICES

(71) Applicant: Schlage Lock Company LLC, Carmel, IN (US)

(72) Inventors: Joseph W. Baumgarte, Carmel, IN (US); Brian C. Eickhoff, Danville, IN (US); Scott Baxter, Carmel, IN (US); Joshua Long, Greenwood, IN (US); Andrew Setter, Carmel, IN (US); Justin D. Seacat, Carmel, IN (US); Nicholas Upton, Indianapolis, IN (US); Madeline Ryals, Kokomo, IN (US); Drew Locketz, Lakewood, CO (US); Paul Avgerinos, Carmel, IN (US)

(21) Appl. No.: 16/678,047

(22) Filed: Nov. 8, 2019

Related U.S. Application Data
(60) Provisional application No. 62/757,409, filed on Nov. 8, 2018.

(51) Int. Cl. H02J 50/30; G07C 9/00

(52) U.S. Cl. CPC H02J 50/30; G07C 9/00111; G07C 2009/0065; G07C 2009/00095; G07C 2009/00642; G07C 9/00174

(57) ABSTRACT

An exemplary system includes a wireless power transmitter in power communication with a power supply, and a wirelessly-powered electronic device powered by the wireless power transmitter. The wirelessly-powered electronic device includes a wireless power receiver and an electronic device in power communication with the wireless power receiver, and may further include an energy storage device. During operation, the transmitter transmits electromagnetic radiation to the receiver, which in turn converts the electromagnetic radiation to electricity that is utilized by the electronic device. In certain embodiments, the transmitter is provided as an infrared laser.

### CROSS-REFERENCE TO RELATED APPLICATIONS

The present application claims the benefit of U.S. Provisional Patent Application No. 62/757,409 filed Nov. 8, 2018, the contents of which are incorporated by reference in their entirety.

### TECHNICAL FIELD

The present disclosure generally relates to wirelessly-powered electronic devices, and more particularly but not exclusively relates to wirelessly-powered access control devices.

### BACKGROUND

Current approaches to powering electronic devices typically involve running wires from a power source to the electronic device, or providing the electronic device with an onboard power supply, such as a battery. Such approaches may be disadvantageous in that end-users may not necessarily desire to run wires to the device, or may disfavor the prospect of having to periodically replace the batteries in the device. For these reasons among others, there remains a need for further improvements in this technological field.

### SUMMARY

An exemplary system includes a wireless power transmitter in power communication with a power supply, and a wirelessly-powered electronic device powered by the wireless power transmitter. The wirelessly-powered electronic device includes a wireless power receiver and an electronic device in power communication with the wireless power receiver, and may further include an energy storage device. During operation, the transmitter transmits electromagnetic radiation to the receiver, which converts the electromagnetic radiation to electricity that is utilized by the electronic device. In certain embodiments, the transmitter is provided as an infrared laser. Further embodiments, forms, features, and aspects of the present application shall become apparent from the description and figures provided herewith.

### BRIEF DESCRIPTION OF THE FIGURES

FIG. 1 is a schematic block diagram of a system according to certain embodiments.

FIG. 2 is a perspective illustration of a closure assembly according to certain embodiments.

### DETAILED DESCRIPTION OF ILLUSTRATIVE EMBODIMENTS

Although the concepts of the present disclosure are susceptible to various modifications and alternative forms, specific embodiments have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. It should further be appreciated that although reference to a “preferred” component or feature may indicate the desirability of a particular component or feature with respect to an embodiment, the disclosure is not so limiting with respect to other embodiments, which may omit such a component or feature. Further, when a particular feature, structure, or characteristic is described in connection with an embodiment, it is submitted that it is within the knowledge of one skilled in the art to implement such feature, structure, or characteristic in connection with other embodiments whether or not explicitly described.

Additionally, it should be appreciated that items included in a list in the form of “at least one of A, B, and C” can mean (A); (B); (C); (A and B); (B and C); (A and C); or (A, B, and C). Similarly, items listed in the form of “at least one of A, B, or C” can mean (A); (B); (C); (A and B); (B and C); (A and C); or (A, B, and C). Further, with respect to the claims, the use of words and phrases such as “a,” “an,” “at least one,” and/or “at least one portion” should not be interpreted so as to be limiting to only one such element unless specifically stated to the contrary, and the use of phrases such as “at least a portion” and/or “a portion” should be interpreted as encompassing both embodiments including only a portion of such element and embodiments including the entirety of such element unless specifically stated to the contrary.

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures unless indicated to the contrary. Additionally, the inclusion of a structural or method feature in a particular figure is not meant to imply that such feature is required in all embodiments and, in some embodiments, may not be included or may be combined with other features.

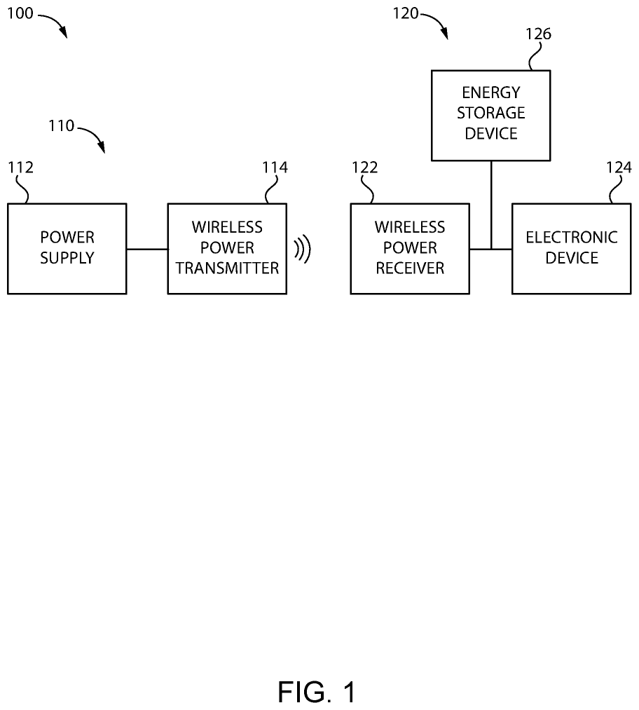

With reference to FIG. 1, illustrated therein is a system 100 according to certain embodiments. The system 100 includes a wireless power supply 110 and a wirelessly-powered electronic device 120. As described herein, the wirelessly-powered electronic device 120 may be provided as an access control device 120, and includes at least one electronic device 124 that is powered by the wireless power supply 110.

The wireless power supply 110 includes a power supply 112 and a wireless power transmitter 114. The power supply 112 may, for example, be provided as line power. The transmitter 114 is in power communication with the power supply 112, and is configured to convert electrical power received from the power supply 112 to a wirelessly-transmitted form of power. In the illustrated form, the transmitter 114 is configured to convert the power to electromagnetic (EM) radiation, such as infrared light. In certain embodiments, the transmitter 114 may be configured to generate the radiation as a directed energy beam. For example, the transmitter 114 may be provided in the form of an infrared laser. While infrared light has been provided as one example, it is to be appreciated that other frequencies of electromagnetic radiation may be utilized. In certain forms, the transmitter 114 may transmit power only when power is required by the device 124 such that the device 124 does not constantly draw power.

The wirelessly-powered electronic device 120 includes a wireless power receiver 122 and an electronic device 124 in power communication with the receiver 122, and may further include an energy storage device 126. The receiver 122 is aligned with the transmitter 114 such that the EM radiation emitted by the transmitter 114 is absorbed by the receiver 122. The receiver 122 is configured to convert the EM radiation to electrical power usable by the electronic device. The receiver 122 may, for example, comprise one or more photovoltaic cells. The electric power may be stored on the energy storage device 126, and/or may be directed to the electronic device 124. The energy storage device 126 may, for example, be provided in the form of a rechargeable battery or a supercapacitor. In certain forms, the wireless power transmitter 114 may act as a continuous power source during operation of the electronic device 124 such that the device 124 draws operating power directly from the receiver 122. In such forms, the energy storage device 126 may be omitted.

As will be appreciated, the electronic device 120 may include additional or alternative features not specifically illustrated in FIG. 1. As one example, the electronic device 120 may include power conditioning circuitry to place the electrical power generated by the receiver 122 and/or stored by the storage device 126 in a condition more suitable for use by the electronic device 124.

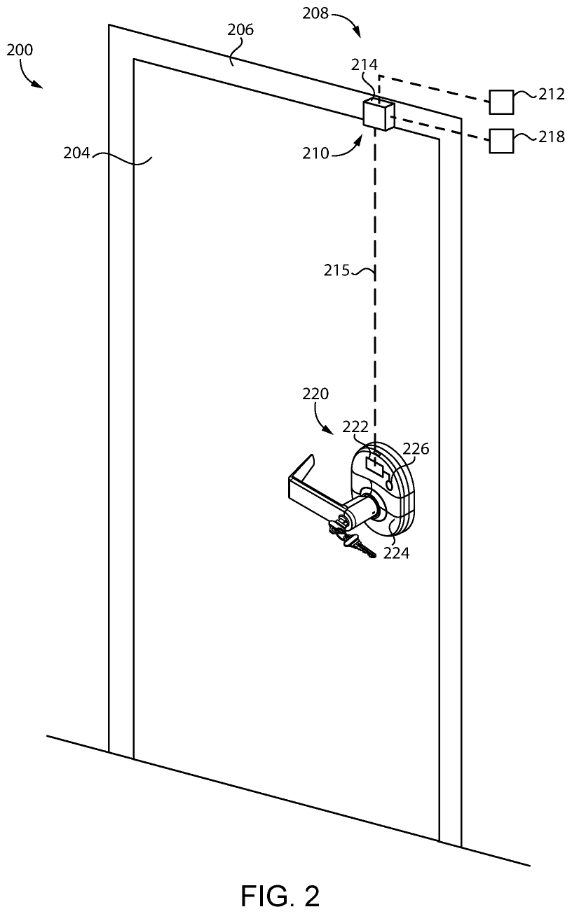

With additional reference to FIG. 2, illustrated therein is a closure assembly 200 according to certain embodiments. The closure assembly 200 includes a door 204 mounted for swinging movement relative to a frame 206, as well as a system 208 according to certain embodiments. The system 208 is an embodiment of the above-described system 100, and similar reference characters are used to indicate similar elements and features. For example, the system 208 includes a wireless power supply 210 and an access control device 220, which respectively correspond to the wireless power supply 110 and the wirelessly-powered electronic device 120. The wireless power transmitter 214 is mounted to the door frame 206, and emits a directed energy beam 215 (e.g., a laser beam) that is absorbed by the wireless power receiver 222.

In the illustrated form, the access control device 220 includes a door lock 224, which comprises at least one electronic device powered by the wireless power. In certain embodiments, the wireless power may be utilized to increase the reading range of a credential reader, or to illuminate a keypad. As another example, the wireless power may be utilized to power a biometric credential reader, such as a fingerprint reader or retinal scanner. Due to the fact that the power is transmitted wirelessly, the lock 224 can be provided with the power throughout the range of motion of the door without requiring a wired hinge. For example, the laser 215 may track the door lock 224 as the door 204 opens and closes. As a result, the power can be provided throughout the range of motion for the door 204 and remain powered while the door 204 is open for an extended period of time. Alternatively, the laser 215 may be focused on a fixed location, such as the location that the receiver 222 occupies when the door 204 is in the closed position.

In addition to door locks, the system 100 may also be used in association with another form of lock, such as a cabinet lock. The electronic device 124 may additionally or alternatively take the form of another device for cabinets. By way of example, the device 124 may be provided as a display for the cabinet, such as an inventory display for a pharmaceutical cabinet. The electronic device 124 may be an illumination device, such as a light for cabinets and/or drawers, or lights to illuminate a walkway outside the home. Alternatively, the electronic device 124 may be a decorative illumination, such as holiday lights.

Another example of an electronic device 124 that may be powered wirelessly is a doorbell. For example, the doorbell may be integrated into the lock itself. With the current rise in popularity of doorbells that are not wired to the home itself, such an application may prove particularly useful. As another example, the electronic device 124 may be provided as an automatic door or window operator. In certain embodiments, the wireless power may be transmitted to a controller of the door itself, which may then distribute the power as needed to other devices. For example, the door may distribute the power to an active noise-cancellation device that actively cancels noise being emitted through the door.

In certain forms, the electronic device 124 may be provided as an Internet of Things (IoT) component. As one example, such an IoT device may be provided as a smart home device. In such forms, the homeowner may remotely control the operation of one or more home components using an app on a mobile device. For example, the IoT device may be an automatic window operator that allows the homeowner to close a window that was accidentally left open, or a powered blind device that allows the blinds to be opened and closed remotely. As another example, the electronic device 124 may be an automatic vacuum cleaner, such as a Roomba. Other smart home potential applications include microphones around the home, which may be used for security (e.g., as a glass-break sensor), or for home assistants.

In certain forms, the electronic device 124 may be provided as a sensor on or around a door. Currently, certain power-consuming sensors can be too expensive and/or cumbersome to merit installation at a door, due to the requirement that the sensor be provided with line power and/or battery power. By eliminating the need for a battery and providing the sensor with a constant wireless power supply, such sensors may become more feasible to install and utilize. Examples of such sensors include smoke or thermal sensors for detecting fire conditions, motion detectors, cameras, facial/voice recognition devices, perimeter security sensors, setting a pet perimeter within the home, or moisture sensors for sprinkler systems.

Another example of an electronic device 124 is powered glass, which transitions between a transparent state and a translucent/opaque state upon the application of electrical power. The electronic device 124 may be provided as a display, such as a touchscreen or illuminated signage. As another example, the display may be a digital photo frame, one that displays advertisements, or a television set. The device 124 may be provided as a damper for an HVAC system.

In certain embodiments, the system 100 may find use in a restroom or bathroom. For example, the device 124 may be provided as a faucet, a toothbrush, a smart seat, or a fan. The device 124 may be utilized in connection with a mirror. For example, the device 124 may be a heated mirror to prevent fogging, or may be a display integrated to the mirror.

In certain forms, the system 100 may find use in a garage. For example, the device 124 may be a vehicle, and the system 100 may be used to provide the vehicle with a trickle charge. The vehicle may be a conventional vehicle, an electric vehicle, or a hybrid vehicle. The vehicle may, for example, be a car, a truck, an SUV, an ATV, or a motorcycle. The device 124 may be a block heater for a vehicle.

In certain embodiments, the electronic device 124 may be associated with a receptacle, such as a physical dropbox, home delivery box, or mailbox. For example, the electronic device 124 may be used to heat or chill the receptacle to an appropriate temperature. Additionally or alternatively, the device 124 may alert the user when a package or the mail has arrived.

The system 100 may be utilized to charge various devices, such as power tools, hearing aids, smart watches, laptops, insulin pumps, cell phones, tablets, Bluetooth headsets, and/or smart glasses. As an alternative to smart glasses, the device may be a fireman's helmet in which a heads up display (HUD) is provided on the visor as a user interface or as augmented reality. The device 124 may heat a component to a point at which it is uncomfortable to touch, but which does not burn the skin. Such an application may discourage children from playing with dangerous objects. A heater may additionally or alternatively be utilized to heat coffee, tea, and other food products.

Although many of the above-described embodiments pertain to use of the system 100 within a residential home, it is to be appreciated that the system 100 may be utilized in other environments. For example, the system 100 may be utilized in connection with a street light. The street light may have a transmitter that facilitates the charging of phones, provides WiFi access, or melts snow from the street light. As another example, the system 100 may be utilized in a hospital environment to power equipment in hallways, to power devices on airplanes, or to act as a DC to AC convertor. As a further example, the device 124 may be provided as a window cleaner machine or a concussion detector.

Additionally, while certain embodiments described hereinabove rely upon the transmitter 114 for transmitting wireless power to the receiver 122, it is also contemplated that the transmitter 114 may be utilized in other capacities. For example, where the transmitter 114 is provided as a laser, the laser may be utilized to exterminate insects or other pests. As another example, the transmitter 114 may be utilized to transmit data to the receiver 122 over infrared data communication protocols, such as data received from an access control system 218. The transmitter 114 may be used in combination with photosensitive paint that absorbs the infrared EM radiation and emits EM radiation in the visible spectrum. The laser could additionally or alternatively be utilized to map one or more rooms using time-of-flight sensors.

While the invention has been illustrated and described in detail in the drawings and foregoing description, the same is to be considered as illustrative and not restrictive in character, it being understood that only the preferred embodiments have been shown and described and that all changes and modifications that come within the spirit of the inventions are desired to be protected.

It should be understood that while the use of words such as preferable, preferably, preferred or more preferred utilized in the description above indicate that the feature so described may be more desirable, it nonetheless may not be necessary and embodiments lacking the same may be contemplated as within the scope of the invention, the scope being defined by the claims that follow. In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary.

What is claimed is:

1. A method, comprising:
mounting a wireless power transmitter to a door frame, wherein a door is movably mounted to the door frame;
connecting the wireless power transmitter to a power supply such that the transmitter is operable to emit electromagnetic radiation using power drawn from the power supply;
mounting an electronic door lock to the door, wherein the door lock comprises a wireless power receiver and an electronic device in power communication with the wireless power receiver;
emitting, by the wireless power transmitter, electromagnetic radiation such that the electromagnetic radiation is absorbed by the wireless power receiver;
generating, by the wireless power receiver, electrical power in response to absorbing the electromagnetic radiation; and
operating the electronic device using the electrical power.

2. The method of claim 1, wherein the wireless power transmitter comprises a laser.

3. The method of claim 2, wherein the electromagnetic radiation comprises infrared radiation.

4. The method of claim 1, wherein the electronic device comprises a credential reader.

5. The method of claim 4, wherein the credential reader comprises a biometric credential reader.

6. The method of claim 1, further comprising moving the wireless power transmitter as the door opens and closes such that the electromagnetic radiation tracks the wireless power receiver.

7. The method of claim 1, wherein the electronic door lock further comprises an energy storage device, the method further comprising storing the electrical power with the energy storage device prior to operating the electronic device with the electrical power.

8. The method of claim 7, wherein the energy storage device comprises one of a rechargeable battery or a supercapacitor.

9. The method of claim 1, wherein the wireless power received comprises at least one photovoltaic cell.

10. The method of claim 1, wherein operating the electronic device comprises unlocking the electronic door lock.

11. A system, comprising:
a wireless power transmitter in power communication with a power supply, wherein the wireless power transmitter is configured to emit electromagnetic radiation;
a wireless power receiver configured to convert the electromagnetic radiation to electrical power; and
an access control device in power communication with the wireless power receiver, wherein the access control device includes an electronic device configured to operate using the electrical power.

12. The system of claim 11, wherein the wireless power transmitter is a directed energy transmitter.

13. The system of claim 12, wherein the directed energy transmitter is a laser.

14. The system of claim 13, wherein the laser is an infrared laser.

15. The system of claim 11, wherein the electronic device comprises a credential reader.

16. The system of claim 15, wherein the credential reader comprises a biometric credential reader.

17. The system of claim 11, wherein the electronic device comprises an electronic lock.

18. The system of claim 17, wherein the electronic lock is operable to transition between a locked state and an unlocked state using the electrical power.

19. The system of claim 11, wherein the electronic device comprises an illumination device configured to emit visible light.

20. The system of claim 11, wherein the wireless power transmitter is further in communication with an access control system, and is configured to transmit data from the access control system to the access control device via the wireless power receiver.

21. The system of claim 11, further comprising an energy storage device operable to store the electrical power, wherein the electronic device is in power communication with the energy storage device.

22. The system of claim 21, wherein the energy storage device comprises one of a rechargeable battery or a supercapacitor.
